(19) United States
(12) Patent Application Publication
(10) Pub. No.: US 2003/0223417 A1
(43) Pub. Date: Dec. 4, 2003

(54) Method of processing data packets

(76) Inventor: Masashi Higashida, Kawasaki-shi (JP)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/163,121

(22) Filed: Jun. 4, 2002

(51) Int. Cl. H04L 12/56

(52) U.S. Cl. 370/389

(57) ABSTRACT

A method of processing data packets having multiple fields by a router includes the steps of receiving a packet; calculating separate check values for each of the packet fields; combining the separately calculated check values; masking the combined check values with a predetermined packet check value; and then comparing the masked, calculated check value with an Access Control List (ACL) entry check value. Only if the calculated check value matches the ACL entry check value is the packet data compared with corresponding fields from the corresponding ACL entry.

### BACKGROUND OF THE INVENTION

The present invention relates generally to a method of comparing large fields of data and, more particularly, to a method of comparing packet data to sequential access control list entries.

Access control lists (ACL) are commonly used to filter packets in routers. Traditionally, ACLs were processed with software, with specific fields in an IP packet being compared to ACL entries sequentially. This approach is computationally expensive because of the byte-by-byte comparisons performed by software, resulting in many clock cycles per entry. With increasing demands on high-speed routers, some hardware approaches have been adopted. One such hardware approach to accelerate the comparisons uses CAM hardware, which achieves speeds of few cycles per ACL entry.

FIG. 1 is a schematic block diagram showing an implementation of sequential software ACL processing or hardware CAM based ACL processing. The ACL entries include packet field criteria for capturing specific packets or flows. The entries contain a mask, which indicates which fields are to be used for comparison, and which fields are to be ignored (“don't care”). When a packet arrives from the network, predetermined packet fields are extracted from the packet. The packet fields and an entry mask (entry[n] mask) are input to a mask block 10 to eliminate the “don't' care” fields. Then, the masked packet fields output from the mask block 10 are compared with the entry's fields (entry[n] fields) with a comparator 12 to determine if there is a match. If the current entry does not match, then the next entry in the ACL is scanned in the same manner. Finally, when all unmasked fields match between the packet and the ACL entry, a permit or deny decision (or other decision) is assigned to the packet for appropriate processing.

FIG. 2 shows the sequential flow of the explicit field comparison approach to ACL processing of FIG. 1. The arrows indicate the comparisons required. As is apparent, the sequential approach is tedious. The CAM approach is much more efficient because each entry (line) is compared immediately. However, the number and width of fields is constrained by the hardware. That is, it is not possible to expand the number of fields for filtering criteria. Such a constraint limits a router or switch's ability to differentiate diverse QoS or security requirements in today's networks.

With the advent of IP version 6 and new multimedia services, the traditional software and even some hardware implementations are faced with performance and size limitations arising from the number and width of fields required for comparisons. The software implementations are challenged with increased data comparisons, while high speed CAM hardware based implementations are challenged by the large 128 bit IP addresses, intermediate headers, and diverse upper layer filtering criteria because of their fixed bit widths. In order to enable packet filtering that differentiates the larger IP addresses as well as diverse upper layer fields efficiently, a method of comparing packet data to sequential ACL entries needs to compare large data widths, and yet achieve high performance.

It would be beneficial to be able to filter variable width packet data quickly and efficiently.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements and instrumentalities shown. In the drawings:

FIG. 1 is a schematic block diagram illustrating conventional sequential software ACL processing or hardware CAM based processing;

FIG. 2 is a sequence of packet and ACL entry field comparisons for conventional, sequential software ACL processing;

FIG. 3 is a schematic block diagram illustrating a simple digest (CRC) comparison approach to ACL processing in accordance with a first embodiment of the present invention;

FIG. 4 is sequence diagram illustrating a sequence of CRC calculations for the simple digest comparison approach of FIG. 3;

FIG. 5 is a schematic block diagram of a digest generation and comparison approach to ACL processing in accordance with a second embodiment of the present invention;

FIG. 6 is a timing diagram of some relationships having a linear combination of CRC components;

FIG. 7 is a sequence diagram showing the sequence of CRC calculations for the digest generation and comparison approach of FIG. 5; and

FIG. 8 is a sequence diagram of a projection error from two different viewpoints.

### DETAILED DESCRIPTION OF THE INVENTION

In the drawings, like numerals are used to indicate like elements throughout.

The present invention provides an efficient method of ACL processing that solves the fixed-width problem faced by conventional CAM hardware ACL processors, while maintaining comparable efficiency. The present invention is based on two properties of message digests, when the “message” is packet fields or ACL entry fields, and the digest calculation algorithm is a linear feedback shift register (LFSR), such as cyclic redundancy check (CRC) or a hash function.

The first property is that a necessary condition for messages, such as entry fields and packet fields, to be equal is their corresponding digests are equal. If two messages are equal, then their digests (CRCs) are equal. If two digests are not equal, then their messages are not equal. If two digests are equal, there is some probability of a collision where two unequal messages yield equal digests. This is true regardless of the length of the message, as long as the compared messages are the same length.

The present invention uses this first property to resolve the fixed-width problem faced by CAM based ACL processors. A long message (packets filtered on many or large fields exceeding the bit width of existing CAM hardware) can be represented by a narrow bit-width digest “fingerprint”. Only when the packet digest and ACL entry digest are equal, is it possible for the actual packets to match the ACL entry. The first property is also used to defer the computationally costly full-field comparison (bit-level) until there is a matching digest. Thus, unnecessary bit-level field comparisons are eliminated. One drawback of the first property, addressed below, is that repeated digest (CRC) calculations can be computationally costly.

The second property is that if the calculation algorithm for a message digest is LFSR (e.g., CRC), then the digest can be decomposed into linearly re-combinable components.

In accordance with the second property, the present invention decomposes the entire message digest into multiple re-usable sub-calculations, termed CRC components or digests below. By calculating these components before comparing the packet fields to the ACL entries, the components can be linearly combined by XOR to derive the digest or CRC value efficiently. This linear combination, by XOR, replaces the costly traditional process of fetching words, masking them, and recalculating their digest or CRC for each ACL entry. Furthermore, the XOR calculation used by the present invention is easily implemented.

The fixed width problem faced by CAM based ACL processors is resolved by substituting potentially long and many packet and entry fields with a fixed-width message digest. Although the present invention is described herein as using cyclic redundancy check (CRC), it is understood that the digest calculation can be any LFSR algorithm.

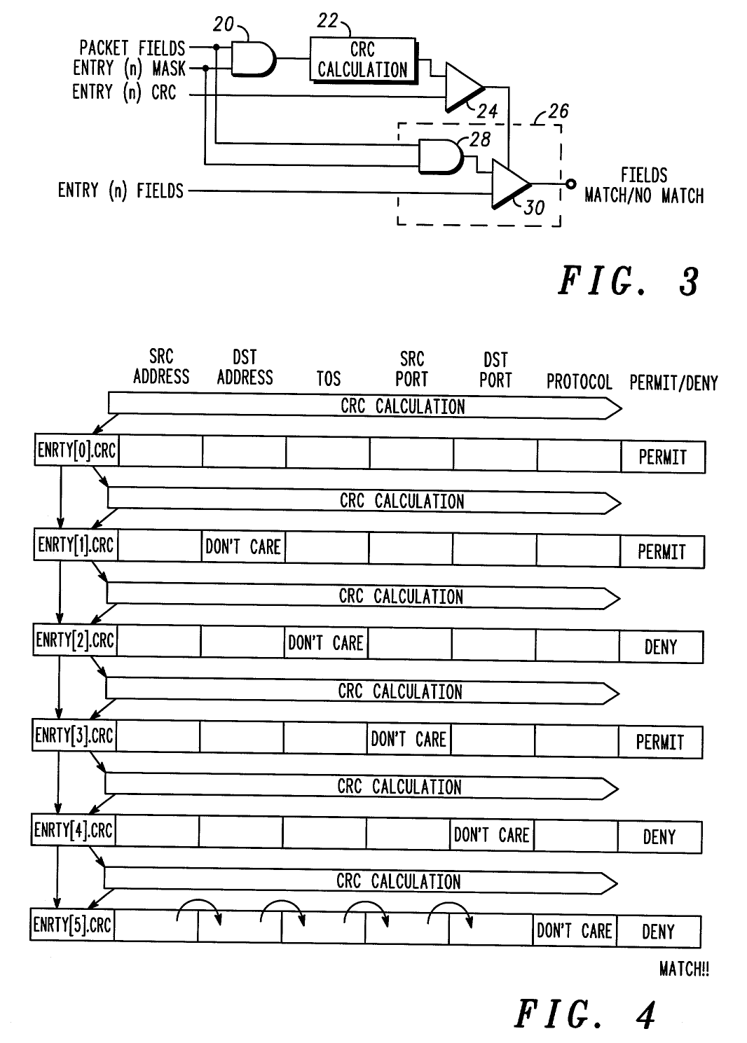

Referring now to FIG. 3, a block diagram that resolves the fixed-width problem described above is shown. Digests (CRC) are pre-calculated and stored with the ACL entry. When a packet arrives, it is masked according to the entry[n]mask with a mask block 20. The mask block 20 may be a simple logic gate, such as an AND gate, as will be understood by those of skill in the art. The masked output from the mask block 20 is input to a digest calculation block 22, which calculates a digest, such as a CRC. Such digest calculation blocks are known and so a detailed description is not necessary for a complete understanding of the invention. The calculated digest output by the digest calculation block 22 is then compared with the provided digest for the entry at a first comparator 24. If the calculated digest does not match the provided digest, then the next, n+1 entry is retrieved and similar processing occurs. If the calculated digest output from the digest calculation block 22 matches the provided digest, as determined by the first comparator 24, then the output from the comparator 24 is used to enable a full field comparison block 26. The full-field comparison block 26 includes a second mask block 28 and a second comparator 30 for performing a full-field comparison like the prior art method of FIG. 1.

It is noted that the first and second mask blocks 20, 28 perform the same function and thus, although two mask blocks are shown, the output from the first mask block 20 could be buffered and input to the second comparator 30.

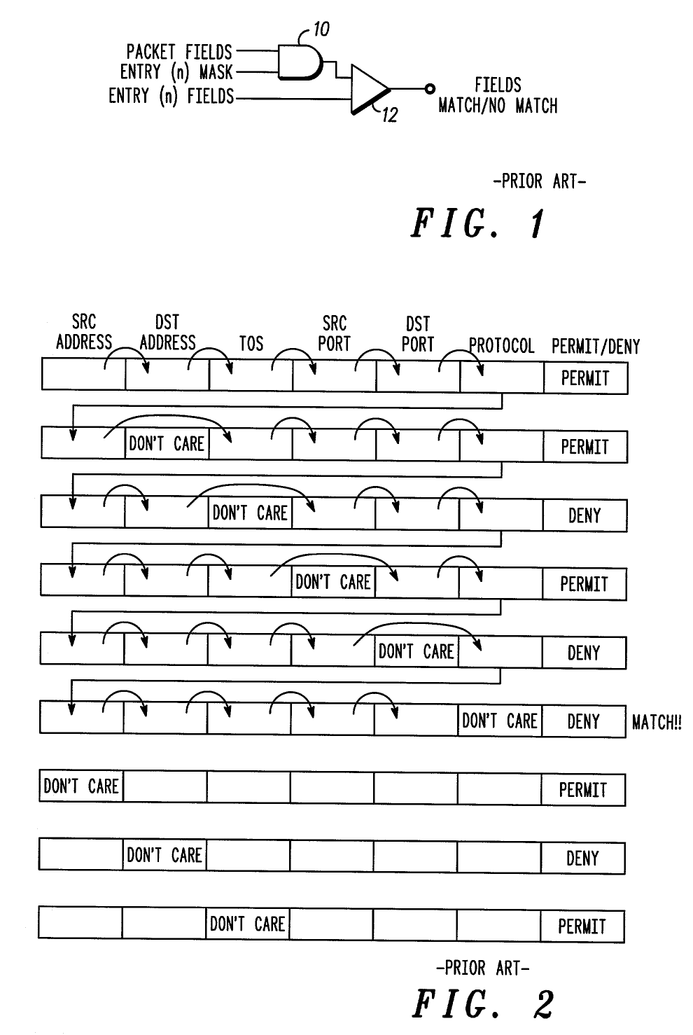

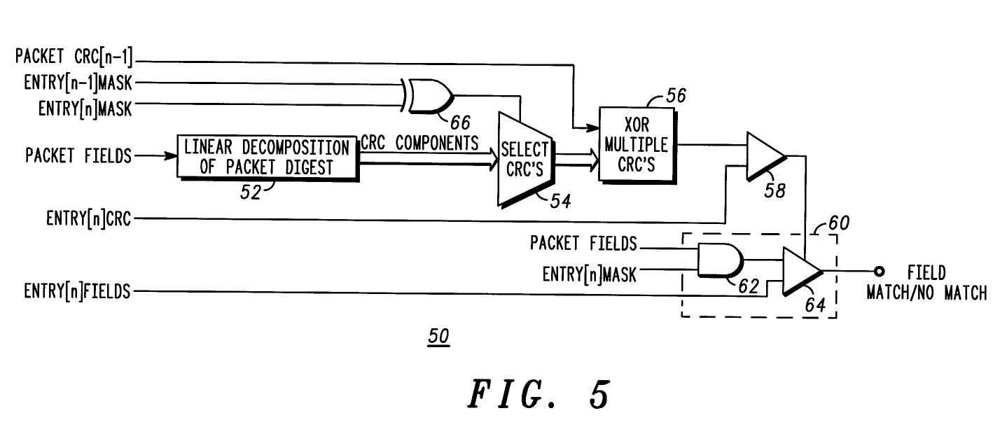

FIG. 4 shows the sequence followed by the approach shown in FIG. 3. When compared with FIG. 2, it can be seen that long bit-width field comparisons are replaced with shorter, digest comparisons. The digest representation removes the bit-width constraint of prior art hardware approaches. That is, a representation of long or many packet fields by a “fingerprint” digest (CRC) is used to defer explicit full-field comparisons. Then, full-field comparisons are performed only if there is a digest match. This saves unnecessary comparisons from being performed. However, the costs of CRC calculation and re-calculating the digest for every entry are significant.

Referring now to FIG. 5, a schematic block diagram of a processor 50 for filtering packet fields in accordance with a second embodiment of the present invention is shown. The processor 50 is just one implementation of an efficient digest generation and comparison method. It will be understood that the processor 50 may be a programmed microprocessor or special hardware, such as a PLA or ASIC. The processor 50 includes a first logic block 52 that receives a packet and calculates a list of combinable CRC components thereof. That is, the block 52 decomposes the packet digest into re-combinable components. The calculated CRC components include a CRC of various packet fields, such as version, class, flow label, length, next header, hop limit, source address, destination address, source port, destination port, and any other fields. The calculated CRC components are combined by a selector 54, as necessary, to create a digest. More particularly, the selected CRC components are provided to an XOR block 56, which combines the components to efficiently mask out selected packet fields from the digest. That is, the XOR block 56 replaces the mask block 20 used in the first embodiment. The packet digest output by the XOR block 56 is then compared to the entry digest (entry[n]CRC) with a first comparator 58. If there is a match, as determined by the first comparator 58, then a full field comparison is performed at the block 60. The block 60 may be the same as the prior art comparison logic shown in FIG. 1. The block 60 includes a mask block 62 and a second comparator 64 and compares the packet field bits to the entry field bits to check for a match. Since this procedure is cycle costly, it is only performed if there is a digest match.

The processor includes an XOR gate 66 to generate a selector enable signal provided to the selector 54. This allows that for each entry “n”, the changing fields compared to entry “n-1” (Δmask) are used to efficiently “update” the digest calculation. The LFSR property of the digest (CRC) makes this feasible. Although other logic elements may be used, a simple XOR eliminates the need for lengthy CRC calculations and requires only a few clock cycles to update the digests for each entry. As in the first embodiment, FIG. 3, only when digests match is an explicit field comparison performed. The pre-calculation cost, performed by the logic block 52, can be amortized over the number of entries the packet will be compared with, resulting in significant efficiency gains, while maintaining flexibility with large or many entry fields.

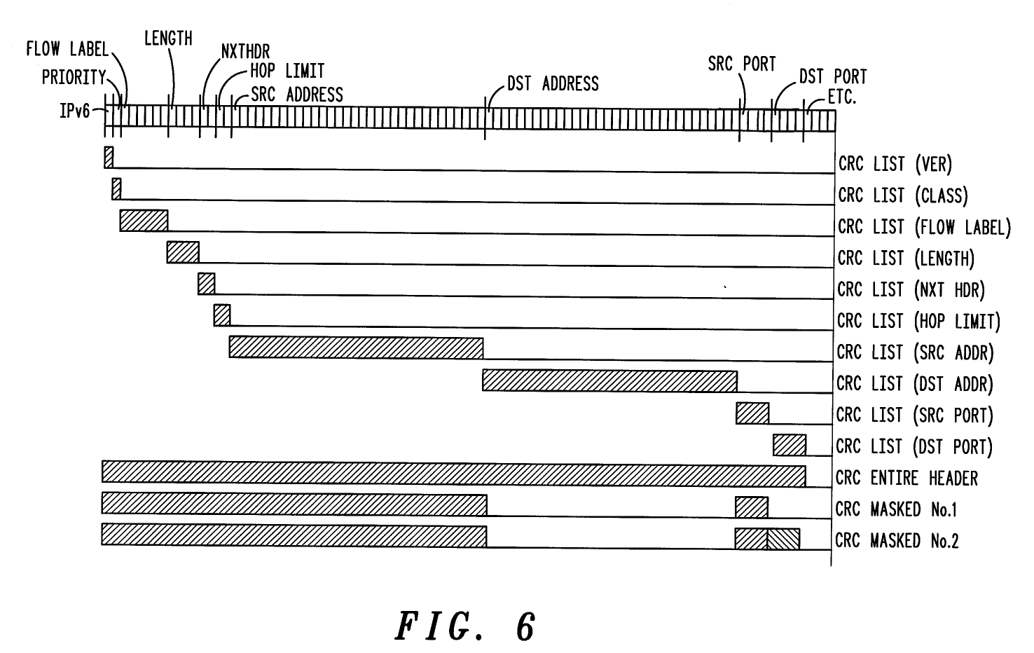

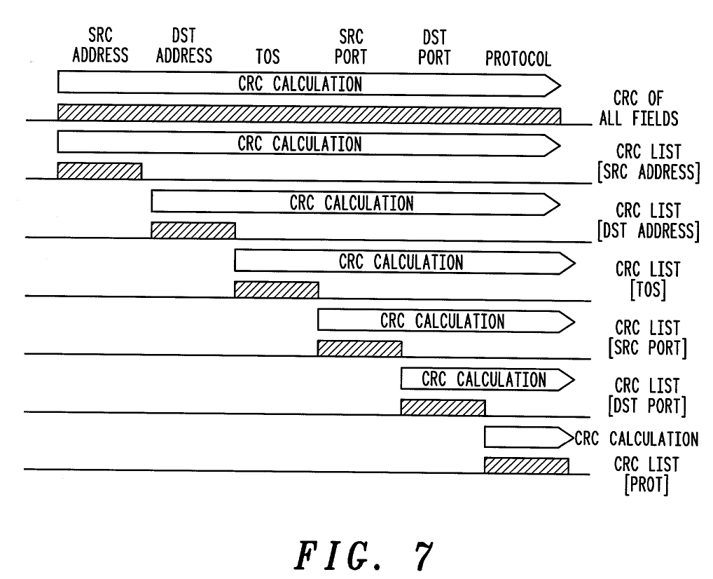

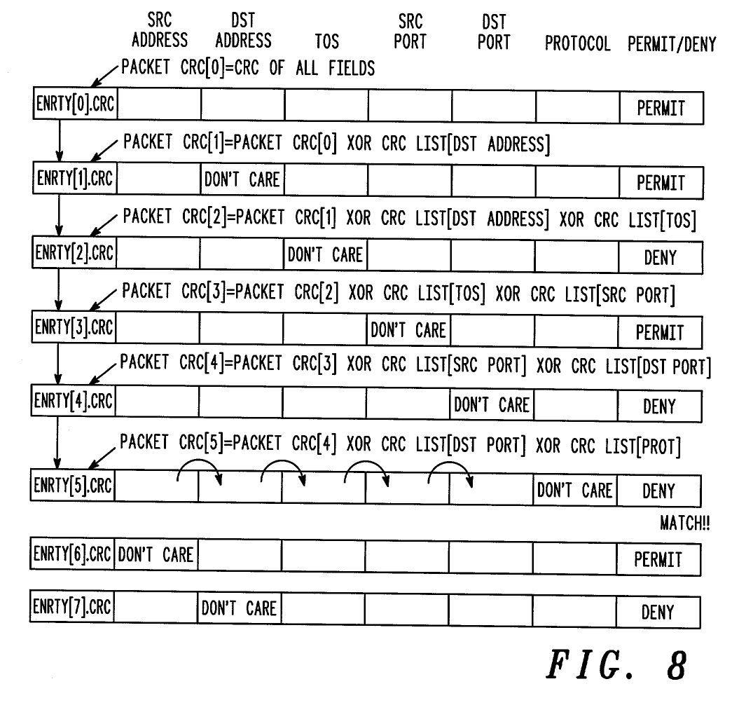

FIG. 6 shows some examples of the packet fields for which separate CRC components are calculated and combined to generate the packet digest (CRC). FIG. 7 shows the sequence of processing, that is, performing CRC calculations of selected packet fields. FIG. 8 shows the sequence of separately calculating CRC values of the selected packet fields and how the separate CRC values are combined using an XOR function.

The present invention is suitable for filtering packets for router products and is preferably implemented with microcode that performs the proposed calculations. However, it will be understood that the inventive concepts described herein may be applied to other applications and may be implemented with specialized hardware, software, or combinations thereof. Further, changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of processing a packet, the packet including a plurality of individual fields, comprising the steps of:
extracting one or more predetermined packet fields;
selecting one or more of the extracted predetermined packet fields for a comparison using a mask;
calculating a separate check value for each of the selected packet fields;
combining the calculated separate check values; and
comparing the combined, calculated check values with an Access Control List (ACL) entry check value.

2. The method of processing a packet of claim 1, further comprising the step of:
masking the combined check values with a predetermined packet check value prior to the comparison step, and then comparing the masked value with the ACL entry check value.

3. The method of processing a packet of claim 1, further comprising the step of comparing the selected packet fields with corresponding fields from a corresponding ACL entry when the calculated check value matches the ACL entry check value.

4. The method of processing a packet of claim 1, wherein the calculated check value is a cyclic redundancy check (CRC) value.

5. The method of processing a packet of claim 1, wherein the calculated check value is a hash function.

6. The method of processing a packet of claim 1, wherein the selecting one or more of the extracted predetermined packet fields for a comparison using a mask comprises XORing the combined check values with a check value of the packet.

7. A method of processing a packet comprising the steps of:
receiving a packet, the packet including a plurality of individual fields;
calculating separate check values for each of the packet fields;
combining the separately calculated check values;
masking the combined check values with a predetermined packet check value; and
comparing the masked, calculated check value with an Access Control List (ACL) entry check value.

8. The method of processing a packet of claim 7, wherein the masking step includes XORing the combined check values with a check value of the packet.

9. The method of processing a packet of claim 7, wherein the combining step comprises linearly combining the separately calculated check values.

10. The method of processing a packet of claim 7, further comprising the steps of:
extracting predetermined packet fields for a comparison using a mask; and
comparing the extracted packet fields with corresponding fields from the corresponding ACL entry when the masked, calculated check value matches the ACL entry check value.

11. The method of processing a packet of claim 7, wherein the calculated check values are cyclic redundancy check (CRC) values.

12. The method of processing a packet of claim 7, wherein the calculated check values are hash functions.
